(19) United States
(12) Patent Application Publication
(10) Pub. No.: US 2015/0028984 A1
(43) Pub. Date: Jan. 29, 2015

(54) THIN FILM TYPE INDUCTOR AND METHOD OF MANUFACTURING THE SAME

(71) Applicant: SAMSUNG ELECTRO-MECHANICS CO., LTD., Suwon-si (KR)

(72) Inventor: Young-Sik KANG, Suwon-si (KR)

(21) Appl. No.: 14/444,649

(22) Filed: Jul. 28, 2014

(30) Foreign Application Priority Data
Jul. 29, 2013 (KR) 10-2013-0089475

(51) Int. Cl. H01F 27/29; H01F 41/04; H01F 27/28

(52) U.S. Cl. CPC H01F 27/29; H01F 27/2804; H01F 41/042
USPC 336/192; 336/200; 29/605

(57) ABSTRACT

Disclosed herein is a thin film type inductor having a coil wiring of a high aspect ratio, including: a substrate on which a through hole of a coil pattern is formed; and a metal layer filled in the through hole.

This application claims the benefit under 35 U.S.C. Section 119 of Korean Patent Application Serial No. 10-2013-0089475 entitled “Thin Film Type Inductor And Method Of Manufacturing The Same” filed on Jul. 29, 2013, which is hereby incorporated by reference in its entirety into this application.

### BACKGROUND OF THE INVENTION

1. Technical Field

The present invention relates to a thin film type inductor and a method of manufacturing the same, and more particularly, to a thin film type inductor with an increased aspect ratio of a coil pattern and a method of manufacturing the same.

2. Description of the Related Art

An inductor is one of the important passive devices configuring an electronic circuit, along with a resistor and a capacitor, and has been mainly used in a power supply circuit, such as a DC-DC converter, within an electronic device or has been widely used as a component for removing noise or configuring an LC resonance circuit. Among them, recently, as the multi function for communications, cameras, games, and the like, is required in a smart phone, a tablet PC, and the like, the use of a power inductor with the reduced loss of current and the increased efficiency has been increased.

The inductor may be classified into various types, such as a multilayered type, a winding type, a thin film type, and the like, according to a structure of the inductor and as the miniaturization and thinness of the electronic device are accelerated, a thin film type inductor has been widely used recently.

The inside of the thin film type inductor is provided with a coil wiring, and thus when the thin film type inductor is applied with power, the thin film type inductor generates a magnetic flux. Herein, the coil wiring is formed by applying silver or silver-palladium conductor paste on a magnetic sheet by a screen printing method and firing the paste. In this case, when a printing precision is reduced or the conductor paste is not fired at an appropriate temperature, the coil wiring is not printed, such that it is difficult to precisely control inductance L, DC resistance characteristic (Rdc), and the like.

Further, as the electronic device is miniaturized and thinned, a demand for the thinness and miniaturization of the inductor used herein has been increased and at the same time, an inductance, a Q value, and the like, above the same level has been demanded. Therefore, in connection with a material, an effort to use a ferrite material having a higher saturation magnetization value has been conducted or in connection with a method, an effort to increase an area of the coil wiring using a printing method for increasing the ration of width to thickness of the coil wiring, that is, an aspect ratio or a structural method for increasing an aspect ratio has been conducted.

Referring to Patent Document (Korean Patent Laid-Open Publication No. 10-2003-0020603), in order to increase the aspect ratio of the coil wiring, the coil wiring is formed to satisfy a predetermined aspect ratio by applying a photosensitive layer having a predetermined thickness on one surface of a substrate, forming an opening of a coil pattern on the photosensitive layer, and plating and filling the inside of the opening.

That is, the above Patent Document discloses a photolithography process for forming an opening of a coil pattern on a photosensitive layer, as one of the processes for forming a coil wiring satisfying a predetermined aspect ratio using a thick photosensitive layer. However, in order to harden a lower portion of the photosensitive layer, exposure and developing conditions need to be strengthened. In this case, due to a thick thickness, an upper portion of the photosensitive layer is excessively hardened and the lower portion thereof is relatively less hardened, and thus an undercut may occur, such that a form of the coil wiring may be uniformly formed.

Further, during a process of removing a seed layer of the lower portion of the coil wiring, an etching solution does not smoothly flow between the patterns of the coil wiring due to a narrow wiring interval and a high thickness of the coil wiring and thus the seed layer is not etched, such that the coil wiring patterns may be short-circuited to each other.

### Related Art Document

### Patent Document

(Patent Document 1) Patent Document: Korean Patent Laid-Open Publication No. 10-2003-0020603

### SUMMARY OF THE INVENTION

An object of the present invention is to provide a thin film type inductor having a coil wiring having a more structurally stabilized form while increasing an aspect ratio and a method of manufacturing the same.

According to an exemplary embodiment of the present invention, there is provided a thin film type inductor, including: a substrate on which a through hole of a coil pattern is formed; and a metal layer filled in the through hole.

The substrate may be made of a magnetic material or a dielectric material.

The metal layer may be made of at least any one metal selected from a group consisting of Ni, Al, Fe, Cu, Ti, Cr, Au, Ag, and Pd.

One surface of the substrate may be provided with a pair of external terminals which is electrically connected to an end of the metal layer.

The substrate may have a size corresponding to a predetermined device size.

The thin film type inductor may further include: an insulating layer formed on a surface of the substrate including an inner wall of the through hole.

According to another exemplary embodiment of the present invention, there is provided a thin film type inductor, including: a substrate having at least two layers which is provided with a through hole of a coil pattern and is multilayered in a thickness direction; and a metal layer filled in the through holes of each layer, wherein the metal layers of each layer form one coil wiring by matching patterns thereof on upper and lower portions.

On surface of the substrate positioned on an uppermost layer among the substrates of at least two layers may be provided with a pair of external terminals which is electrically connected to an end of the coil wiring.

According to still another exemplary embodiment of the present invention, there is provided a method of manufacturing a thin film type inductor, including: forming a through hole of a coil pattern on a substrate; and forming a metal layer in the through hole.

The forming of the through hole of the coil pattern on the substrate may include: attaching a photoresist pattern on one surface of the substrate; etching a substrate portion exposed through an opening of the photoresist pattern; and delaminating the photoresist pattern.

The forming of the metal layer in the through hole may include: attaching the substrate formed with the through hole on a dummy substrate of which the one surface is formed with a seed layer; performing electroplating on the seed layer through a lead-in wire; and removing the dummy substrate.

The method of manufacturing a thin film type inductor may further include: after the forming of the through hole of the coil pattern on the substrate, forming an insulating layer on the surface of the substrate including the inner wall of the through hole.

The method of manufacturing a thin film type inductor may further include: after the forming of the metal layer in the through hole, planarizing an upper surface of the substrate.

The substrate in which the metal layer is formed in the through hole may be multilayered in at least two layers, but the metal layers on upper and lower layers may be multilayered so that patterns thereof match each other.

According to still yet another exemplary embodiment of the present invention, there is provided a method of manufacturing a thin film type inductor, including: forming a groove of a coil pattern on a substrate having a predetermined thickness; forming a metal layer in the groove: and removing a lower portion of the substrate corresponding to a dummy part so as to expose a lower surface of the metal layer.

A thickness of the substrate may be set to be a sum of a predetermined device thickness and a thickness of the dummy part.

The forming of the groove of the coil pattern on the substrate having a predetermined thickness may include: attaching a photoresist pattern on one surface of the substrate; performing half etching on a substrate portion exposed through an opening of the photoresist pattern; and delaminating the photoresist pattern.

The forming of the metal layer in the groove may include: forming a seed layer on the substrate including an inner wall of the groove; performing electroplating on the seed layer through a lead-in wire; and removing the seed layer on the substrate.

The metal layer may be formed in the groove and the substrate from which the dummy part is removed may be multilayered in at least two layers, but the metal layers on upper and lower layers may be multilayered so that patterns thereof match each other.

### BRIEF DESCRIPTION OF THE DRAWINGS

FIG. 1 is a perspective view of a thin film type inductor according to an exemplary embodiment of the present invention.

FIG. 2 is a cross-sectional view taken along the line I-I′ of FIG. 1.

FIG. 3 is a perspective view of a thin film type inductor according to another exemplary embodiment of the present invention.

FIG. 4 is a cross-sectional view taken along the line II-II' of FIG. 3.

FIGS. 5 to 9 are process diagrams sequentially illustrating a method of manufacturing a thin film type inductor according to an exemplary embodiment of the present invention.

FIGS. 10 to 14 are process diagrams sequentially illustrating a method of manufacturing a thin film type inductor according to still another exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

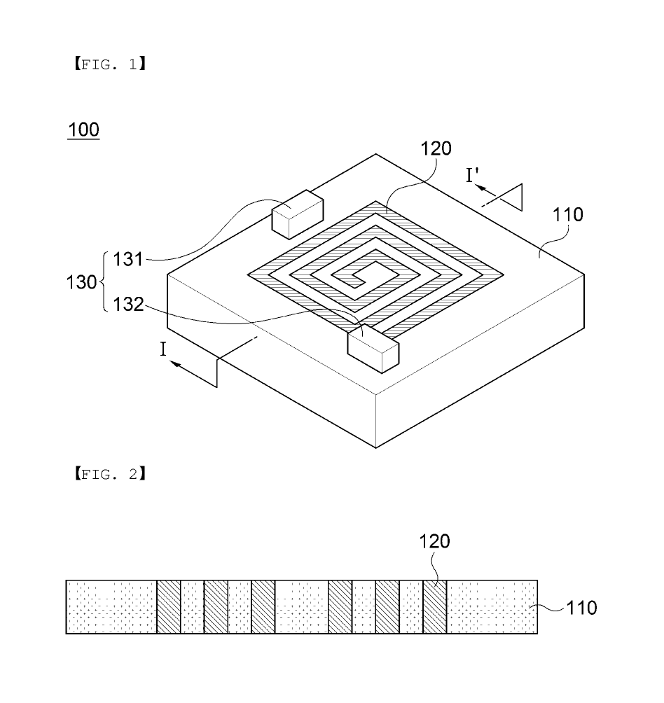

FIG. 1 is a perspective view of a thin film type inductor according to an exemplary embodiment of the present invention and FIG. is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 2, a thin film type inductor 100 according to the exemplary embodiment of the present invention may include a substrate 110 and a metal layer 120 formed by penetrating through the substrate 110.

The substrate 110, which is a hexahedron of a ceramic material, becomes a device body. Therefore, as constituents of the substrate 110, for example, a magnetic ceramic, such as one or more ferrite selected from Ni—Zn-based, Ni—Cu—Zn-based, and Mg—Zn-based ferrites and a ferrite glass composite material, a dielectric ceramic, such as barium titanate, alumina, and alumina glass composite material, or the like may be used.

Further, the substrate 110 may also be manufactured at a predetermined size, for example, a size of 2012 (2.0 mm×1.2 mm×1.2 mm), 1005 (1.0 mm×0.5 mm×0.5 mm), 0603 (0.6 mm×0.3 mm×0.3 mm), 0402 (0.4 mm×0.2 mm×0.2 mm), and the like.

The metal layer 120 becomes a layer on which a coil wiring is formed and may be formed by penetrating through the substrate 110. That is, the substrate 110 is formed with a through hole of a coil pattern and the metal layer 120 may be formed by being filled in the through hole.

The metal layer 120 may be made of at least any one metal selected from a group consisting of Ni, Al, Fe, Cu, Ti, Cr, Au, Ag, and Pd, all of which have excellent conductivity.

Meanwhile, as illustrated in FIG. 1, the metal layer 120 may be formed to be surrounded in a quadrangular shape, but may also be formed to be surrounded in a circular shape. As illustrated in FIG. 1, when the metal layer is surrounded in a quadrangular shape, a cross sectional area of a coil may be expanded, a high-capacity inductance is easily implemented and when the metal layer is surrounded in a circular shape, flowability of current is improved, such that the DC current characteristics (Rdc) may be improved.

A pair of external terminals 130 for conducting the metal layer 120 with the outside may be provided on one surface of the substrate 110. That is, the external terminal 130 may be configured of a first external terminal 131 which is electrically connected to one end of the metal layer 120 and a second external terminal 132 which is electrically connected to the other end of the metal layer 120. In this configuration, the first external terminal 131 may be connected to one end of the metal layer 120 through a circuit within a PCB substrate on which the thin film type inductor according to the exemplary embodiment of the present invention is mounted.

As such, the thin film type inductor 100 according to the exemplary embodiment of the present invention uses the substrate 110 corresponding to a predetermined device size to be able to be implemented at an accurate device size and the metal layer 120 having a desired aspect ratio may be formed by controlling a pattern width of the through hole in which the metal layer 120 is filled.

Meanwhile, although not illustrated in the drawings, in order to secure insulation between the substrate 110 and the metal layer 120, a surface of the substrate 110 including an inner wall of the through hole may be further provided with an insulating layer. That is, before the metal layer 120 is filled in the thorough hole of the substrate 110, the insulating layer is formed in the inner wall of the through hole, and therefore the metal layer 120 formed by being filled in the through hole is insulated from the substrate 110 by the insulating layer. Herein, the insulating layer may be formed by anodizing the substrate 110 using an anodizing method, a plasma method, and the like.

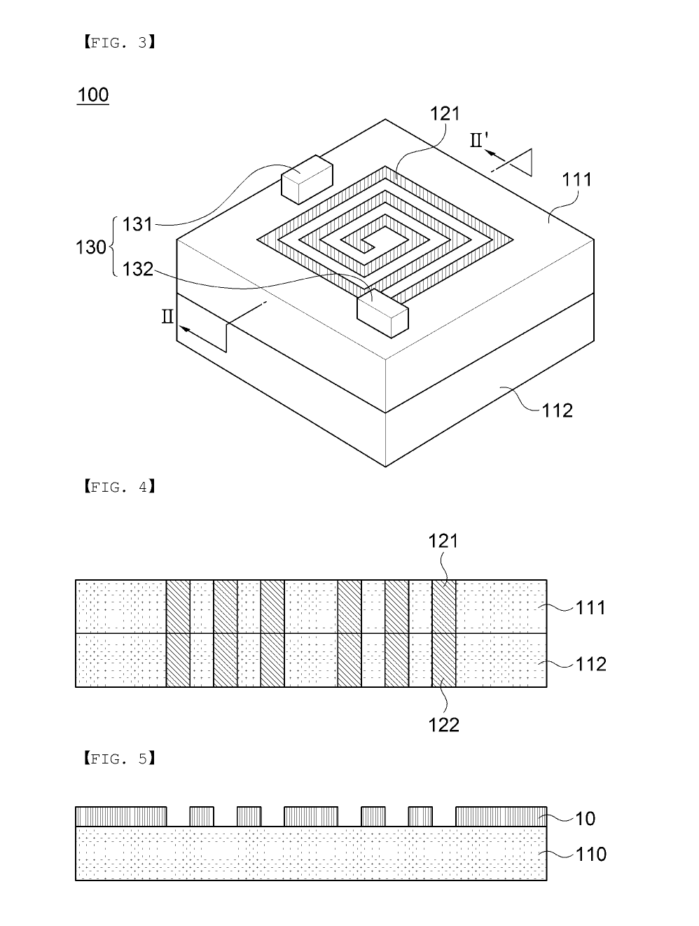

FIG. 3 is a perspective view of a thin film type inductor according to another exemplary embodiment of the present invention and FIG. 4 is a cross-sectional view taken along the line II-II′ of FIG. 3. Referring to FIGS. 3 and 4, the thin film type inductor according to the exemplary embodiment of the present invention may be configured in a form in which a multilayer substrate 110 is multilayered in a thickness direction. FIGS. 3 and 4 illustrate that two substrates 111 and 112 are multilayered, but the number of layers of the multilayered substrate 110 may be two or more.

Similar to FIG. 1, the substrates 111 and 112 of each layer are provided with the through hole of the coil pattern and the through holes of each layer may be filled with metal layers 121 and 122. Herein, as illustrated in FIG. 4, the metal layers 120 of each layer form one coil wiring by matching the patterns thereof on the upper and lower portions. In this case, the pair of external terminals 130 for conducting is provided on one surface of the substrate 111 of an uppermost layer and thus is electrically connected to both ends of the coil wiring.

As such, when the thin film type inductor is configured by multi-layering the plurality of substrates 110, the aspect ratio of the coil wiring configured of the multilayer metal layer 120 is in proportion to the number of layers of the multilayer substrate 110, such that the DC resistance characteristic (Rdc) and the Q characteristic may be largely improved.

Hereinafter, a method of manufacturing a thin film type inductor according to the exemplary embodiment of the present invention will be described.

FIGS. 5 to 9 are process diagrams sequentially illustrating a method of manufacturing a thin film type inductor according to the exemplary embodiment of the present invention and a process of forming a through hole 110a of a coil pattern on the substrate 110 is performed.

Describing in detail the process of forming the through hole 110a, as illustrated in FIG. 5, photoresist patterns 10 are attached to one surface of the prepared substrate 110 having a predetermined size. In detail, when the photosensitive photoresist is attached to one surface of the substrate 110 and is then developed by being irradiated with ultraviolet rays in the state in which the photoresist is blocked with a mask, a predetermined pattern is formed on the photoresist.

Next, as illustrated in FIG. 6, the substrate 100 portion exposed through the opening between the photoresist patterns 10 is etched by wet etching or dry etching to form the through hole 110a.

When the through hole 110a is formed as described above, a process of delaminating the photoresist patterns 10 and a process of forming the metal layer 120 in the through hole 110a are performed.

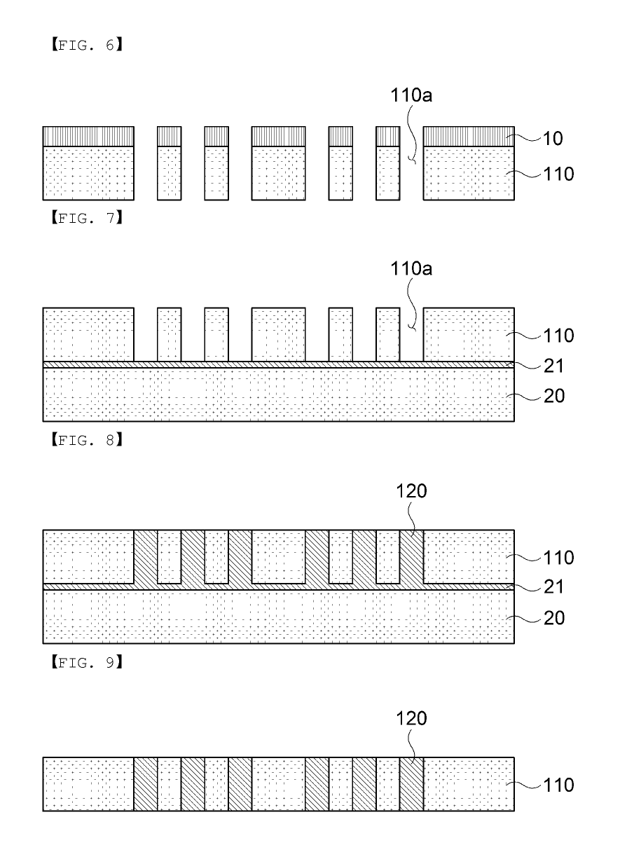

The metal layer 120 is formed by electroplating. First, as illustrated in FIG. 7, the substrate on which the through hole 110a is formed is attached on a dummy substrate 20 of which the one surface is formed with a seed layer 21 which becomes a lead-in wire of the electroplating. Next, when the seed layer 21 is subjected to the electroplating through the lead-in wire, the metal layer may be formed in the through hole 110a by plating and growing a metal material from the lower portion of the through hole 110a (FIG. 8).

In this case, when the metal material is plated outside the through hole 110a due to over-plating, the patterns of the metal layers 120 may be short-circuited to each other. Therefore, to cope with the case, a process of forming the metal layer 120 and then planarizing the upper surface of the substrate 110 may be further performed.

When the metal layer 120 is formed as described above, as illustrated in FIG. 9, the thin film type inductor according to the exemplary embodiment of the present invention which is configured as the substrate 110 in which the metal layer 120 is formed in the through hole 110a by removing the dummy substrate 20 may be finally completed. Alternatively, the substrate 110 obtained after the removal of the dummy substrate 20 is multilayered in at least two layers, but the metal layers 120 of each layer are multilayered so that the patterns thereof match each other, thereby manufacturing the thin film type inductor illustrated in FIG. 3.

Meanwhile, in order to insulate the substrate 110 from the metal layer 120 after the through hole 110a is formed, a process of forming an insulating layer by anodizing the surface of the substrate 110 including the inner wall of the through hole 110a using the anodizing method, the plasma method, and the like may be further performed.

FIGS. 10 to 14 are process diagrams sequentially illustrating a method of manufacturing a thin film type inductor according to still another exemplary embodiment of the present invention and the thin film type inductor according to the exemplary embodiment of the present invention may be manufactured by using a method of etching a thickness of a part of the substrate 110 without forming the through hole 110a by full etching.

To this end, first, as illustrated in FIG. 10, the substrate 110 having a predetermined thickness is prepared. The thickness of the substrate 110 may be set to be a sum of a predetermined device thickness and a thickness of a dummy part 110′. Herein, the dummy part 110′ is a lower region of the substrate 110 which is not etched in the subsequent process and when the device size to be manufactured is, for example, 1005, the substrate 110 may be formed to have a thickness of 0.7 mm which is a sum of thickness 0.5 mm of the device and thickness 0.2 mm of the dummy part 110′ arbitrarily set.

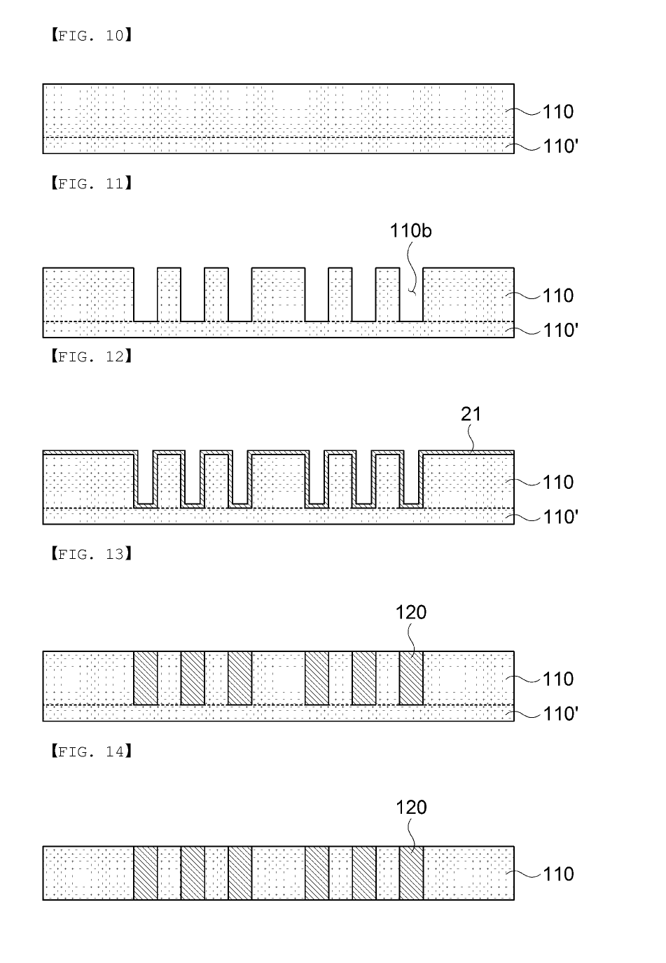

As such, when the substrate 110 having a predetermined thickness is prepared, as illustrated in FIG. 11, a process of forming a groove 110b of the coil pattern is performed. The groove 110b may be formed by attaching the photoresist pattern and performing half etching on the substrate 110 portion exposed through the opening of the photoresist pattern.

Unlike full etching performing etching to penetrate through the entire substrate 110, the half etching, which is a technology of etching only a portion of the substrate 110 thickness, does not penetrate through the dummy part 110′ beneath the substrate 110 due to the groove 110b.

When the groove 100b is formed by the half etching, a process of delaminating the photoresist pattern and then forming the metal layer 120 in the groove 110b is performed. As illustrated in FIG. 12, this may be made by forming the seed layer 21 on the substrate 110 including the inner wall of the groove 110b and performing the electroplating on the seed layer 21 through the lead-in wire to fill and plate the inside of the groove 110b. When the inside of the groove 110b is completely filled with metal, as illustrated in FIG. 13, the metal layer 120 may be obtained by removing the seed layer 21 on the substrate 110 to prevent the short-circuit between the patterns.

Next, as illustrated in FIG. 14, the thin film type inductor according to the exemplary embodiment of the present invention may be finally completed by removing the dummy part 110′ of the substrate 110 so as to expose the lower surface of the metal layer 120. Alternatively, the metal layer 120 is formed in the groove 110b and the substrate 110 from which the dummy part 110′ is removed is multilayered in at least two layers, but the metal layers 120 of each layer are multilayered so that the patterns thereof match each other, thereby manufacturing the thin film type inductor illustrated in FIG. 3.

According to the thin film type inductor in accordance with the exemplary embodiments of the present invention, it is possible to accurately implement the accurate device size by using the substrate corresponding to the predetermined device size as the device body.

Further, it is possible to increase the aspect ratio of the coil wiring by the simpler method without causing the defects, such as undercut, since the coil wiring is configured of the metal layer penetrating through the substrate.

The present invention has been described in connection with what is presently considered to be practical exemplary embodiments.

Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A thin film type inductor, comprising:
a substrate on which a through hole of a coil pattern is formed; and
a metal layer filled in the through hole.

2. The thin film type inductor according to claim 1, wherein the substrate is made of a magnetic material or a dielectric material.

3. The thin film type inductor according to claim 1, wherein the metal layer is made of at least any one metal selected from a group consisting of Ni, Al, Fe, Cu, Ti, Cr, Au, Ag, and Pd.

4. The thin film type inductor according to claim 1, wherein one surface of the substrate is provided with a pair of external terminals which is electrically connected to an end of the metal layer.

5. The thin film type inductor according to claim 1, wherein the substrate has a size corresponding to a predetermined device size.

6. The thin film type inductor according to claim 1, further comprising:
an insulating layer formed on a surface of the substrate including an inner wall of the through hole.

7. A thin film type inductor, comprising:
a substrate having at least two layers which is provided with a through hole of a coil pattern and is multilayered in a thickness direction; and
a metal layer filled in the through holes of each layer,
wherein the metal layers of each layer form one coil wiring by matching patterns thereof on upper and lower portions.

8. The thin film type inductor according to claim 7, wherein one surface of the substrate positioned on an uppermost layer among the substrates of at least two layers is provided with a pair of external terminals which is electrically connected to an end of the coil wiring.

9. A method of manufacturing a thin film type inductor, comprising:
forming a through hole of a coil pattern on a substrate; and
forming a metal layer in the through hole.

10. The method according to claim 9, wherein the forming of the through hole of the coil pattern on the substrate includes:
attaching a photoresist pattern on one surface of the substrate;
etching a substrate portion exposed through an opening of the photoresist pattern; and
delaminating the photoresist pattern.

11. The method according to claim 9, wherein the forming of the metal layer in the through hole includes:
attaching the substrate formed with the through hole on a dummy substrate of which the one surface is formed with a seed layer;
performing electroplating on the seed layer through a lead-in wire; and
removing the dummy substrate.

12. The method according to claim 9, further comprising:
after the forming of the through hole of the coil pattern on the substrate, forming an insulating layer on the surface of the substrate including the inner wall of the through hole.

13. The method according to claim 9, further comprising:
after the forming of the metal layer in the through hole, planarizing an upper surface of the substrate.

14. The method according to claim 9, wherein the substrate in which the metal layer is formed in the through hole is multilayered in at least two layers, but the metal layers on upper and lower layers are multilayered so that patterns thereof match each other.

15. A method of manufacturing a thin film type inductor, comprising:
forming a groove of a coil pattern on a substrate having a predetermined thickness;
forming a metal layer in the groove: and
removing a lower portion of the substrate corresponding to a dummy part so as to expose a lower surface of the metal layer.

16. The method according to claim 15, wherein a thickness of the substrate is set to be a sum of a predetermined device thickness and a thickness of the dummy part.

17. The method according to claim 15, wherein the forming of the groove of the coil pattern on the substrate having a predetermined thickness includes:
attaching a photoresist pattern on one surface of the substrate;
performing half etching on a substrate portion exposed through an opening of the photoresist pattern; and
delaminating the photoresist pattern.

18. The method according to claim 15, wherein the forming of the metal layer in the groove includes:
forming a seed layer on the substrate including an inner wall of the groove;
performing electroplating on the seed layer through a lead-in wire; and
removing the seed layer on the substrate.

19. The method according to claim 15, wherein the metal layer is formed in the groove and the substrate from which the dummy part is removed is multilayered in at least two layers, but the metal layers on upper and lower layers are multilayered so that patterns thereof match each other.
